(19) United States
(12) Patent Application Publication
(10) Pub. No.: US 2018/0047236 A1
(43) Pub. Date: Feb. 15, 2018

(54) DEVICE AND METHOD FOR RECEIVING GOODS

(71) Applicant: Deutsche Telekom AG, Bonn (DE)

(72) Inventors: Sebastian Heinz, Bonn (DE); Michael Schmidt-Gabriel, Wessling (DE); Johannes Scholl, Munich (DE); Reimer Hintzpeter, Hamburg (DE)

(21) Appl. No.: 15/555,556

(22) PCT Filed: Mar. 4, 2016
(86) PCT No.: PCT/EP2016/000383

§ 371 Date: Sep. 5, 2017

(30) Foreign Application Priority Data
Mar. 6, 2015 (DE) 10 2015 002 796.4

(51) Int. Cl. G07C 9/00; G06Q 50/28; B60R 9/00

(52) U.S. Cl. CPC G07C 9/00896; B60R 9/00; G06Q 50/28; G07C 2009/0092; G07C 2009/00769

(57) ABSTRACT

A method for receiving goods from a delivery warehouse includes: arranging, at least temporarily, a goods receipt box on the outside of the body of a motor vehicle; transporting a good from a delivery warehouse to a parking location of the motor vehicle; and placing the good into the goods receipt box.

### CROSS-REFERENCE TO RELATED APPLICATIONS

This application is a U.S. National Phase application under 35 U.S.C. §371 of International Application No. PCT/EP2016/000383, filed on Mar. 4, 2016, and claims benefit to German Patent Application No. DE 10 2015 002 796.4, filed on Mar. 6, 2015. The International Application was published in German on Sep. 15, 2016 as WO 2016/142047 under PCT Article 21(2).

### FIELD

The invention relates to a method for receiving goods, for example from a delivery warehouse or from another consignor. The invention also relates to a system for receiving goods.

### BACKGROUND

The receipt of goods is well known in the prior art and is usually implemented in that a good is sent by a consignor to a person, for example by a shipping provider, but in the simplest case in that a good is picked up directly by a person, for example at a delivery warehouse.

In the commercial field, a typical case is that, for example, people who work in the field must bring goods to customers in order for the customer to sell these goods or in order to install these goods at the customer's premises or at least use these at the customer's premises, for example for assembly or repair purposes. By way of example, mention can be made of sales personnel or also specialist engineers, who are commissioned by customers to carry out their specialist work at the customer's premises, for example fitters or maintenance personnel.

The desired or needed goods are routinely picked up by such a person working in the field firstly from a delivery warehouse, for example a wholesaler, or from the company employing said person, before said person travels to the customer. This procurement method in this case takes up a not insignificant portion of the available working time.

It is also known for needed or desired goods to be delivered directly to the customer or to the person working in the field by shipping providers, however this presupposes that the good to be delivered can also be received in practical terms, otherwise another delivery attempt would have to be made, which is costly in terms of manpower and financial expense.

### SUMMARY

In an exemplary embodiment, the present invention provide a method for receiving goods from a delivery warehouse. The method includes: arranging, at least temporarily, a goods receipt box on the outside of the body of a motor vehicle; transporting a good from a delivery warehouse to a parking location of the motor vehicle; and placing the good into the goods receipt box.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIGS. 1 and 2 show, in a side view and perspective view, a system according to the invention formed of a goods receipt box and a retaining frame.

FIG. 3 shows arms in the deflected position.

FIG. 4 shows, in a side view, a folded-out goods receipt box with side walls which extend between cover element and bottom element.

### DETAILED DESCRIPTION

Exemplary embodiments of the present invention provide a container for receiving and also for sending goods, by means of which container goods can be received at the address of the receiving person at practically any time, without the consignee or consignor having to be at home. For this purpose, a container is temporarily fastened to the door of the house and a shipping provider can place, for example, an ordered good in said container. Although, legally, the consignee has received the good as a result of this process, because the good has been delivered within the sphere of the consignee, the good is only effectively received once the consignee returns home.

In the case of people working in the field who need the ordered or desired goods for example for professional reasons, this means that the good is only received at the end of the working day if the person does not pick up the goods themself, in accordance with the variant discussed at the outset, or authorize a third party to do so.

Exemplary embodiments of the invention provide a method and a system by means of which desired or needed goods can actually be received at any time and at any location by any person, for example people working professionally in the field. Here, a high level of security should preferably also be provided, so as to prevent goods from passing into unauthorized hands.

In accordance with an exemplary embodiment of the method, a goods receipt box is at least temporarily arranged on the outside of the body of a vehicle, in particular of a motor vehicle, used by the person, and a good needed/desired by the person is transported from a delivery warehouse to the location of the parked vehicle, in particular motor vehicle, and is placed into the goods receipt box.

In an exemplary embodiment, the invention provides a system for receiving goods at a vehicle, in particular at a motor vehicle, comprising a retaining frame, which can be at least temporarily fastened to a vehicle, in particular to a motor vehicle, in particular to the luggage compartment lid of the vehicle, and a goods receipt box, which can be at least temporarily fastened to the retaining frame and which has a cover to be opened and closed by authorized persons. A goods receipt box of this kind, in particular the cover element thereof or the cover itself, can have an electromechanical lock, for example, which can be opened using a PIN code, for example via a keypad, for example having capacitive touch functionality, or using an electronic key (e.g. RFID transponder or by near-field or far-field communication, such as Bluetooth or GSM), or using biometric features (e.g. fingerprint).

Multiple people are in possession of a vehicle, in particular motor vehicle, for example a car, whether as owners or merely as users of a vehicle made available to them, in particular motor vehicle (e.g. company car/service vehicle), and a vehicle, in particular motor vehicle, of a person needing a good is routinely also located in the vicinity of the person, regardless of whether the person is at work or at home or at another location during their free time. Here, a vehicle is also understood to mean vehicles that are not driven, for example trailers.

In particular, individuals working professionally in the field are routinely out and about with a vehicle, in particular motor vehicle, used for business purposes in order to visit customers and perform their work there.

By means of the system and the method according to the invention, a good can thus be delivered to a person practically at any time, for example even when the person is absent from their vehicle, in particular motor vehicle, in particular also outside of working hours or even at nighttime, at the location of the vehicle, in particular motor vehicle of the person, the person finding the good when they return to the vehicle, in particular motor vehicle.

For example, individuals working in the field can hereby receive goods for a second customer whilst they are still working on the premises of a first customer. Or, an individual working in the field can receive goods overnight from a wholesaler, which can then be taken directly to the customer the next day, without the person having to first pick up the goods themself from the wholesaler.

Here, the invention can also provide for the goods receipt box, together with a good, to be delivered to the location of the vehicle, in particular motor vehicle, in particular when information is provided that there is no goods receipt box arranged on the retaining frame on the vehicle, in particular motor vehicle. In this case, the goods receipt box, including the good placed therein, can be fastened to the retaining frame by a delivering person. For example, this can be done against payment of a deposit sum, which is refunded upon return of the goods receipt box to the delivery service or the delivery warehouse.

The invention is not limited to the example of a person working in the field. It is also not absolutely necessary that only an authorized person, in addition to delivery workers, has or receives access to a goods receipt box.

In one embodiment, it is also possible to arrange a goods receipt box or a plurality of goods receipt boxes on a vehicle, which box or boxes can be used by a number of people to receive goods, and as appropriate even to send goods. A mobile “packing station” can thus be formed, at which different people/customers can pick up their goods. For example, a trailer can be equipped for this purpose with a plurality of goods receipt boxes or initially also only with a plurality of retaining frames for goods receipt boxes.

Here, the invention can provide for a retaining frame to be at least temporarily fastened to the outside of the vehicle, in particular motor vehicle, and for the goods receipt box to be fastened to the retaining frame. Here, the retaining frame can be fastened to the vehicle preferably on a vehicle door/flap of the vehicle, for example a side or rear door or a luggage compartment lid, or another, preferably pivotable, vehicle part.

For example, for goods receipt boxes used in a standardized manner on the market, retaining frames can be provided which are customized either in respect of the vehicle used, in particular motor vehicle, or which are designed in a variable manner, so that a retaining frame can be fastened to practically any vehicle type, in particular motor vehicle type. A retaining frame thus forms an adapter, which can remain on the vehicle, in particular motor vehicle, whereas in accordance with the invention, a goods delivery box can be temporarily fastened to the retaining frame, in particular when the vehicle, in particular motor vehicle, remains out of use.

For example, the goods receipt box can be designed in such a way that it comprises a lower bottom element, in particular tub-shaped bottom element, and an upper cover element which can be opened and closed, collapsible side walls, in particular foldable side walls, extending between the bottom element and cover element, the retaining frame comprising at least one first fastening component and the goods receipt box comprising at least one second fastening component, and the first and second fastening component being able to be connected to one another, in particular via positive and/or non-positive engagement, at least one locking element also being arranged on the cover and being able to be introduced into the fastening component by closing the cover, said locking element in particular locking said fastening component in this way.

By means of a goods receipt box of this kind, it is ensured that it takes up little space in the empty state and is for example stowed in the car until the point of use, or, if it remains on the outside of the vehicle, in particular motor vehicle, it is made smaller in order to reduce the wind load.

For this purpose, it is advantageous if the cover element and bottom element can be moved towards one another and away from one another in order to reduce or increase the internal volume of the goods receipt box, and in particular if the bottom element is designed as a tub or shell, the laterally upright walls of which, in the completely folded state of the goods receipt box, fully surround the cover element and the collapsed side walls located between the bottom element and cover element, that is to say in particular the upper edge of the tub protrudes beyond the cover.

The collapsibility of the side walls extending between the bottom element and cover element can be provided for example by a textile tube, for example made of a fabric that is resistant to cutting, possibly a composite fabric, for example comprising Kevlar fibers. The textile tube can have a substantially rectangular cross-section, which corresponds substantially to the cross-section of the cover element. For example, the textile tube can comprise stitched folds in order to form a rectangular cross-section of this type.

A plurality of rigid side wall elements hinged to one another can also be provided in order to make a particular side wall collapsible or foldable.

In particular, it can also be provided for a textile tube to surround rigid side wall elements hinged to one another.

In order to attain windproofness and waterproofness in the side wall region, it can be provided to use film hinges or integral hinges for the hinged connection of rigid side wall elements.

The invention can provide for the goods receipt box to be fastened by producing a connection, in particular a positive and/or non-positive engagement, between at least one first fastening component of the retaining frame and at least one second fastening component of the goods receipt box, the first and second fastening components being locked to one another by closing a cover of the goods receipt box and the first and second fastening components being unlocked from one another by opening said cover of said goods receipt box.

It is hereby ensured that in particular the locked goods receipt box can be removed from the frame only by a person who is also authorized to open the goods receipt box.

In order to gain access to the goods receipt box, that is to say in particular in order to be able to open the cover of the cover element, the invention can provide, in one embodiment, for a security code for opening the goods receipt box to be set and to be transmitted by telecommunication at least to a delivery person employed by the delivery warehouse.

For example, the person on whose vehicle the goods receipt box is arranged can have their own personal PIN code, which typically always remains the same, but in particular can also change, which is input at a keypad of the goods receipt box in order to open said box. This person can thus gain access to the content of the goods receipt box at any time.

By contrast, in a possible embodiment, the person delivering a good does not have their own PIN code that stays the same, but receives a PIN code to be used to open the box, for example by telecommunication at a telecommunications device of the delivery person. Only via the telecommunicated PIN code can a delivery person thus place the good in the goods receipt box. For example, this PIN code to be used by the delivery person can be generated at the time of ordering of a good and can be associated with the good, for example a consignment tracking number of the good, which for example is arranged on the good itself, for example in the form of a machine-readable barcode.

It can be provided for a delivery person, for delivery of the good, to scan the consignment tracking number using a mobile reader, which displays the associated PIN code number to the delivery agent on the basis of the consignment tracking number. For this purpose, the PIN code can be retrieved from a database by telecommunication or is already present in the form of a data record in the reader, for example because these PIN code data were already loaded onto the reader beforehand, in particular from a database.

Generally, it can be provided for the goods receipt box to be registered on a central server (backbone), which is incorporated in a telecommunications network, the goods receipt box preferably being connected to the server for communication therewith via a telecommunications unit in the goods receipt box, and said telecommunications unit is also connected to the server for communication therewith, or such connections can be established at least electively, for example via mobile communication, in particular GSM, 3G or LTE. A person using the goods receipt box and/or also a service provider who provides such goods receipt boxes, in a preferred embodiment, can manage user data and settings/parameters, such as security codes for access, for example via a database of the server.

The security code for opening the goods receipt box can be generated for example by a central server, in particular the aforementioned central server, on which the goods receipt box is registered, and in particular hereafter can be telecommunicated to the goods receipt box and a communications device of the delivery person, but can also be generated by a security device of the goods receipt box itself and can be transmitted from a communications unit of the goods receipt box to a communications unit of a delivery person. This communication can occur directly between the goods receipt box and the delivery person, for example via mobile communication (GSM) or near-field communication (e.g. Bluetooth), but can also occur via interposed servers/databases, in this case typically by telecommunication via mobile communication (e.g. GSM) or via bidirectional satellite communication.

By means of the aforementioned embodiment, it can be ensured that the person on whose vehicle the goods receipt box is arranged always has access to the box, by contrast with delivery workers, who only have access in a particular case.

Here, it can also preferably be provided for a PIN code of a delivery person to be able to be used only once in order to open the cover. Once the good has been placed in the box and the cover has been closed, the cover cannot be opened again with the used PIN code.

However, in particular if a number of people apart from the delivery workers are intended to have access to a goods receipt box, the invention can also provide for these people to each be sent required security codes as well, for example PIN numbers, by telecommunication to a preferably mobile communications device, in particular from the central server or the box itself. Here, the security codes can be generated and transmitted in the same way as described previously, with the sole difference that a code is then transmitted to the using person and not to the delivery person.

With simultaneous generation of security codes for the using person and a delivery person, the invention can provide for different codes for these two people to be used, in particular communicated as described previously, with regard to a good that is to be delivered.

In the system according to the invention, it can be provided for the at least one first fastening component to be designed as an arm of the retaining frame that can be pivoted about an axis of rotation and that can be inserted into a second fastening component on the goods receipt box. Two first fastening components are preferably arranged on the retaining frame.

The at least one second fastening component can preferably be arranged on or in the frame of the cover element surrounding the opening that can be closed by the cover. In particular, at least two second fastening components can be arranged on opposite sides of the frame, which preferably correspond in position to the aforementioned two pivotable arms on the retaining frame once these have been brought into a position pivoted away from the frame or protruding therefrom. The cover element of the goods receipt box can thus be slid onto the arms of the retaining frame, which hereby enter the hollow profiles arranged on the frame.

In accordance with the invention, the goods receipt box is locked on the retaining frame in that, when the cover is closed, at least one locking element, preferably two locking elements, arranged on the cover engages/engage in the connected first and second fastening components, whereby these can no longer be pulled apart from one another. Once the cover has been closed, the goods receipt box can thus no longer be removed from the retaining frame.

In order to achieve universal usability of the retaining frame and also easy removability, it can be preferably provided for the retaining frame to comprise a base element, in particular a base frame, from which at least three, preferably four, supports, in particular length-adjustable supports, protrude. The supports arranged parallel to one another have, at their free ends, contact elements, for example suction cups, by means of which the supports can be placed on the body of a vehicle, in particular motor vehicle. Tensioning elements, in particular tensioning straps, are preferably arranged on the base element, in particular in the vicinity of the points at which the supports are connected to the base element, and the free ends of said tensioning elements comprise connection elements for fastening to the vehicle, in particular motor vehicle.

These connection elements can be designed as hooks for engaging around a corresponding edge of the vehicle, in particular motor vehicle, in particular an edge of the luggage compartment lid.

The base element, in particular the base frame, can be arranged in a vertical plane by adjusting the length of the supports. At least the components of the base element are then preferably arranged in this plane, i.e. the frame parts in the case of a frame-like design of the base element.

The pivotable arms of the retaining frame can have a vertical axis of rotation if the base element is arranged in a vertical plane, and in particular can be pivoted hereby from a position bearing against the base element into a position protruding from the base element.

In addition to the securing of the cover using the electromechanical lock mentioned at the outset, the cover element of the goods receipt box can also comprise at least one purely mechanical closure element which can be manually actuated from the outside and by means of which the cover can be fastened to the frame. This closure element can be provided for example as a transport lock, but can also be designed to draw the cover tightly onto an upper edge of the frame of the cover element and thus attain a waterproofness.

In one embodiment, the invention can provide for the goods receipt box to be arranged in a manner mounted on the retaining frame solely via the cover element. The bottom element of the goods receipt box is then suspended freely beneath the cover element.

A fastening that is preferred by comparison because it is more stable provides for the bottom element to also be connected to the retaining frame. For this purpose, the bottom element, in particular the tub-shaped bottom element, can have at least one third fastening component on the goods receipt box, which third fastening component can be placed around at least parts of the base element, in particular in the lower region thereof, via positive engagement and can be releasably connected to the base element, in particular via a pin or split pin connection using at least one pin/split pin, which can be guided through aligned cutouts in the third fastening element and the base element.

A third fastening component of this type is preferably arranged on the side of the bottom element pointing towards the retaining frame.

Furthermore, it can be provided for a number plate carrier to be arranged on the retaining frame, in particular on the base element thereof and/or on the bottom element of the goods receipt box. It is hereby ensured that a vehicle, in particular motor vehicle, can be moved permissibly in road traffic, even if the retaining frame, including the goods receipt box as applicable, is mounted on the vehicle, in particular motor vehicle. Alternatively or additionally, it can also be provided to arrange a plate or plate carrier for displaying another designation, for example a name, on the base element and/or bottom element.

In addition, an anchoring element, in particular comprising a flexible band, which can be inserted into a gap region between a door or luggage compartment lid and the vehicle body, can be arranged on the goods receipt box, in particular on the bottom element thereof and/or on the retaining frame. Even if the goods receipt box were removed from the retaining frame or the retaining frame were removed from the vehicle, in particular motor vehicle, there would still be a connection via the anchoring element to the vehicle, in particular motor vehicle.

In order to increase the security against theft, it can be provided for a connection element between anchoring element and goods receipt box or retaining frame to be protected against severing. In the case of a flexible, textile design of the connection element, for example as a strap, metal fibers/strands can be present in the connection element.

An embodiment of the system and use thereof according to the method will be explained on the basis of the following drawings.

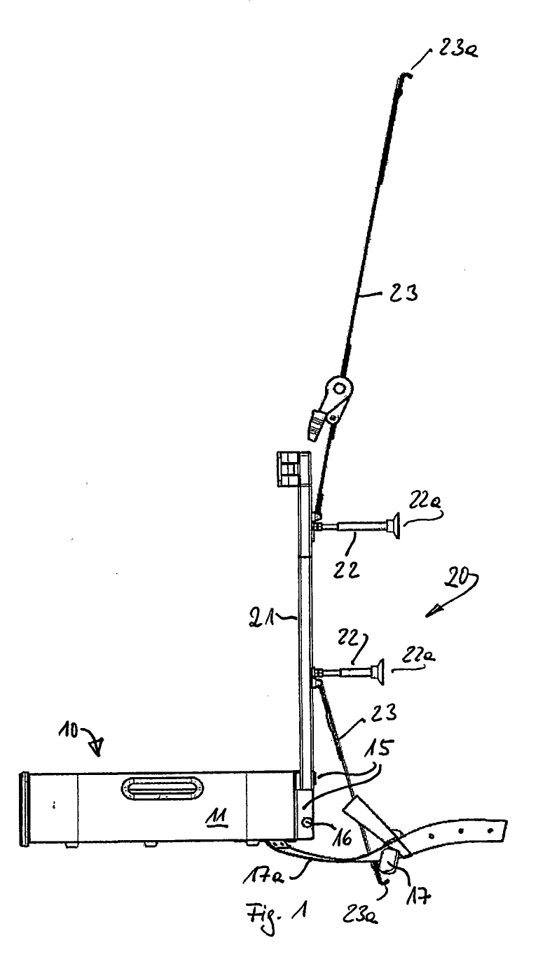

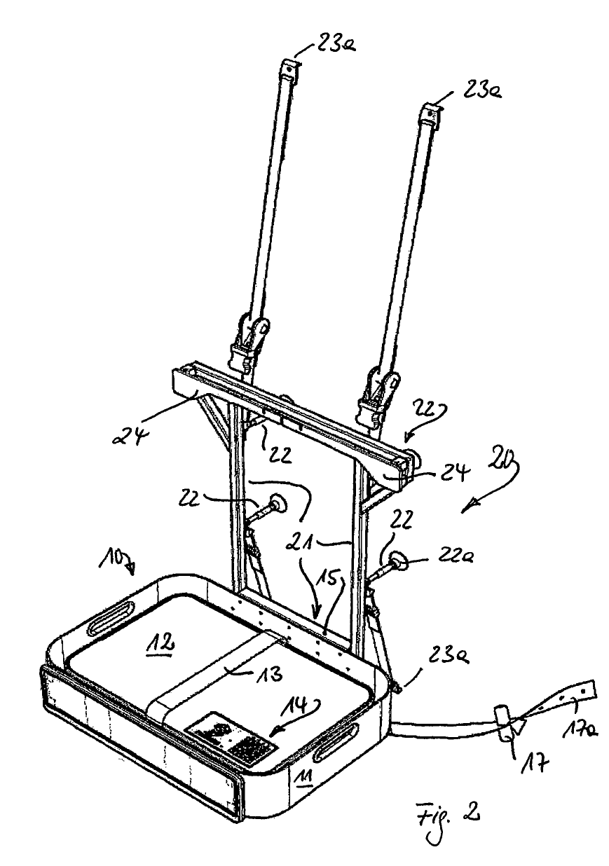

FIGS. 1 and 2 show, in a side view and perspective view, a system according to the invention formed of a goods receipt box 10 and a retaining frame 20.

The goods receipt box is shown in FIGS. 1 and 2 in the collapsed/folded state and comprises a tub-shaped bottom element 11, the bottom element surrounds the cover element 12, which has a handle 13 extending thereover. A keypad 14 is also arranged in the cover of the cover element 12 for inputting a PIN code. A communications unit (not shown) for near-field and/or far-field communication can also be integrated in the cover element.

On the rear side of the bottom element 11 pointing towards the frame 20, said bottom element, in the sense of the previous description, has third fastening elements 15 in the form of L-shaped or U-shaped profiles and tabs, by means of which the bottom element can be mounted on the retaining frame 20, preferably via positive engagement, in particular on struts of the frame-shaped base element 21 of the retaining frame 20. In order to produce a secure connection, a pin 16 can pass through a third fastening element and a strut of the base element 21, for example under spring bias.

An anchoring element 17 is arranged on the bottom element 11 via a textile strap 17a. The anchoring element and strap can be placed in a door gap of a vehicle, in particular motor vehicle, so that the anchoring element 17 is arranged in the vehicle.

Supports 22, which are length-adjustable, protrude from the base element 21 of the retaining frame 20 in the direction of a vehicle (not shown here), in particular motor vehicle. For example, the supports are designed as sleeves having an internal thread which are supported on threaded rods. Four supports are provided here, which are arranged in the corners of a virtual rectangle.

The free ends of the supports 22 have a contact element 22a, for example in the form of suction cups.

A tensioning strap 23 is arranged on the retaining frame, in particular on the base element 21, in the vicinity of each connection point between base element 21 and a support 22. The tensioning straps are length-adjustable, the ones illustrated here at the top via a ratchet. A hook 23a is arranged on the free end of each tensioning strap 23 and can be used to secure a tensioning strap to an edge of a door, in particular the luggage compartment lid. By tensioning the straps, the frame is fastened together with the supports to the selected door or luggage compartment lid.

FIG. 2 in particular shows, at the top of the base element, two arms 24 arranged pivotably thereon, here in a position in which the arms are pivoted close to the frame or the base element 21.

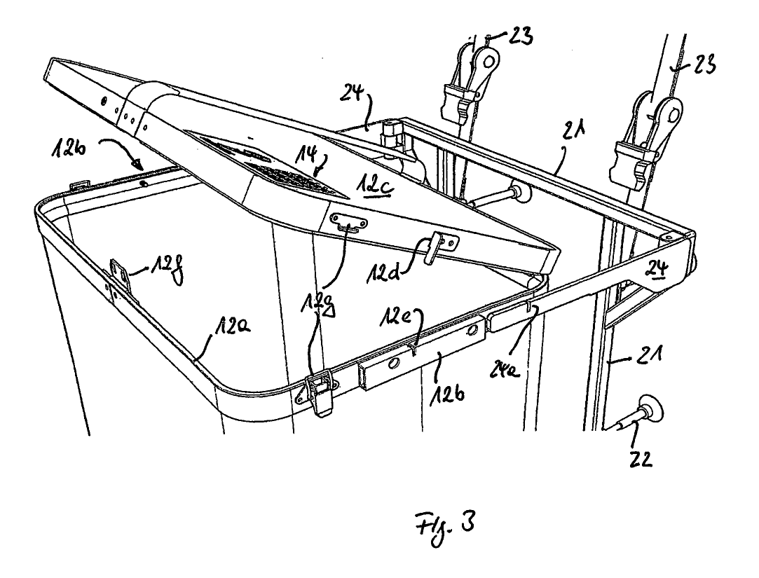

FIG. 3 shows these arms 24 in the deflected position. The arms 24 form the first fastening component in the sense of the general description further above.

Mutually opposed hollow profiles 12b, which form the second fastening component, are arranged on the lower frame 12a of the cover element 12 on the sides that run parallel to the deflected arms 24, in this case the short sides. These hollow profiles are fastened for example via rivets. The arms 24 can be slid into these hollow profiles so that the cover element 12 is supported as a whole by the arms 24.

Here, it can be seen that a locking element 12d is fastened to the cover 12c of the cover element 12 on the side thereof and above the corresponding hollow profile 12b and has a downwardly protruding tab. In the lowered state of the cover 12c, this tab passes through a cutout 12e formed in the top of a hollow profile 12b and enters the hollow profile 12b. Provided that an arm 24 is inserted into the hollow profile 12b, the tab also passes into a cutout/slot 24a in the end region of an arm, so that the hollow profile 12b and arm 24 are locked to one another.

Only when the cover 12c is opened can the goods receipt box thus be removed from the arms of the retaining frame.

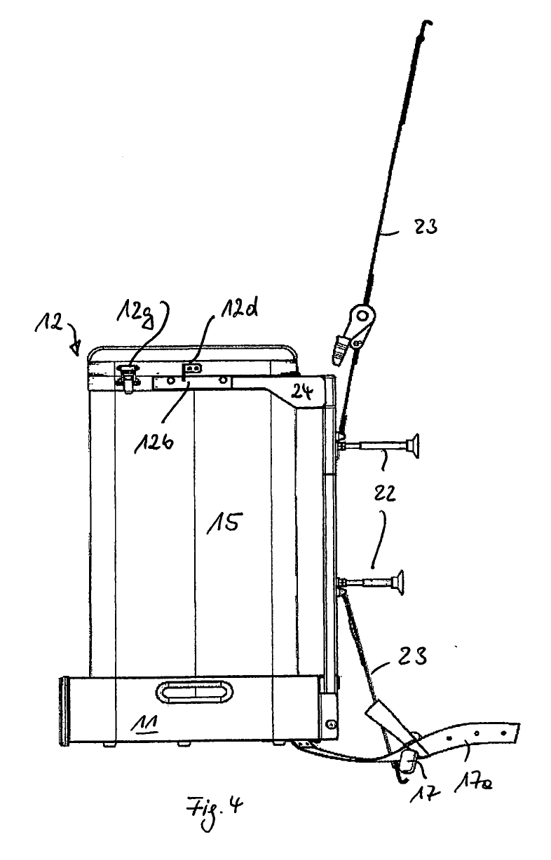

FIG. 4 shows, in a side view, the folded-out goods receipt box with the side walls 15, which extend between cover element 12 and bottom element 11. Here, the side walls are preferably made of a textile that is resistant to cutting, for example comprising Kevlar portions and/or metal portions.

In addition to the electromechanical locking mechanism, of which only a locking tab 12f on the frame 12a is shown, the cover element comprises purely mechanical, manually actuatable closure elements 12g, which connect the frame 12a and the cover 12c to one another, for example as a transport lock.

The method according to the invention, in an exemplary application, provides, for example, for a person working in the field to have permanently fastened the retaining frame to the vehicle used for business, in particular motor vehicle.

If the need for a good, which for example is needed professionally, can be identified, the person places an order for the needed good directly or indirectly at a delivery warehouse, for example the delivery warehouse of the employer or also of a wholesaler. This can be done for example via an app on a mobile telephone or via a personal computer.

Regardless of this description of one example, and thus in all variants, it can generally be provided for information relating to the parking location of the vehicle, in particular motor vehicle, to be transmitted in particular constantly or regularly or at least when an order is placed at the delivery warehouse, in particular transmitted to a server operated by the delivery warehouse or to a server that hosts a central database in which the location/parking location of the goods receipt box can be read by any authorized individual for the purpose of the delivery of goods. Location information of this type can be associated for example with a goods receipt box registered there.

The location information can be generated by a satellite-assisted localization device (e.g. a GPS receiver) in the goods receipt box or in the vehicle, in particular motor vehicle, on which the box is arranged. Alternatively, it can be generated by a mobile communications device of the person at the location of the vehicle and can be made available, for example at the time of ordering or in an app on the communications device in which the method according to the invention is organized.

At the latest after an order has been placed, the person working in the field mounts the goods receipt box on the retaining frame and locks it there by closing the lid once the box has been mounted in place.

Still during working hours, for example immediately after the order has been placed, or even after working hours, for example at nighttime, the delivery warehouse delivers the good to the goods receipt box at the known location via a delivery person.

When placing the order, a security code, for example a PIN number, was also generated, for example by a security device of the goods receipt box, the electronics of which in particular are involved in the ordering process by communication, or by a central server, on which the box is registered and which is communicatively involved in the ordering process. The server can be the server that also hosts the aforementioned database.

The delegated delivery person sent by the delivery warehouse with the ordered good receives the access code issued, for example via an imprint on the good or via communication to a communications device carried by the delivery person, for example by means of which a consignment tracking number is scanned from the good at the time of delivery. Using the access code provided to the delivery person, said person can open the goods receipt box, place the good therein, and close the cover again, whereby the access code can expire.

The person working in the field, when searching the vehicle, in particular motor vehicle, finds the delivered good in the box and can use this immediately. Trips in person to a delivery warehouse are saved in this way.

The invention can provide for the goods receipt box itself to transmit a message regarding the successful delivery of the good to the ordering person. This can be advantageous in particular if a delivery is made still within working hours, so that the person is made aware that the good can be retrieved from the box.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for receiving goods from a delivery warehouse, the method comprising:
arranging, at least temporarily, a goods receipt box on the outside of the body of a motor vehicle;
transporting a good from a delivery warehouse to a parking location of the motor vehicle; and
placing the good into the goods receipt box.

2. The method according to claim 1, wherein the good is placed into the goods receipt box while a user of the vehicle is absent.

3. The method according to claim 1, wherein a retaining frame is at least temporarily fastened to a door/flap of the motor vehicle, and the goods receipt box is fastened to the retaining frame.

4. The method according to claim 3. wherein the goods receipt box is fastened to the retaining frame via a connection, between a first fastening component of the retaining frame and a second fastening component of the goods receipt box, the first and second fastening components being locked to one another by closing a cover of the goods receipt box and the first and second fastening components being unlocked from one another by opening the cover of the goods receipt box.

5. The method according to claim 1, wherein the goods receipt box is delivered together with a good to the location of the motor vehicle when information is provided that there is no goods receipt box arranged on a retaining frame on the motor vehicle.

6. The method according to claim 1, wherein a security code for opening the goods receipt box is set and is transmitted via telecommunication to a delivery person employed by the delivery warehouse, wherein the security code is generated by a security device of the goods receipt box or by a central server and is transmitted from a communications unit of the goods receipt box or the central server to a communications unit of a delivery person.

7. A system for receiving goods at a motor vehicle, comprising:
a retaining frame, configured to be at least temporarily fastened to a vehicle door/flap of a motor vehicle; and
a goods receipt box, configured to be at least temporarily fastened to the retaining frame, wherein the goods receipt box comprises a lid configured to be opened and closed by authorized persons.

8. The system according to claim 7, wherein the goods receipt box further comprises:
a lower tub-shaped bottom element;
an upper cover element configured to be opened and closed; and
collapsible side walls extending between the bottom element and cover element;
wherein the retaining frame comprises a first fastening component, and
wherein the goods receipt box further comprises a second fastening component; and
wherein the first and second fastening components are configured to be connected to one another;
wherein at least one locking element is arranged on the cover and is configured to be introduced into the first and second fastening components by closing the cover so as to lock the first and second fastening components.

9. The system according to claim 8, wherein the second fastening component is arranged on or in the frame of the cover element surrounding the opening that can be closed by the cover.

10. The system according to claim 9, wherein second fastening component is formed by a hollow profile, into which the first fastening component of the retaining frame is configured to be inserted.

11. The system according to claim 10, wherein the first fastening component is an arm of the retaining frame that is configured to be pivoted about an axis of rotation and that is configured to be inserted into the second fastening component.

12. The system according to claim 8, wherein the retaining frame comprises a base frame, from which at least three length-adjustable supports protrude, and tensioning arranged on the base element;
wherein the tensioning straps are in the vicinity of the points at which the length-adjustable supports are connected to the base element frame, and the free ends of the tensioning elements straps comprise connection elements for fastening to the motor vehicle.

13. System The system according to claim 12, wherein the connection elements are hooks for engaging around an edge of the luggage compartment lid or a door of the motor vehicle.

14. The system according to claim 11, wherein the arm of the retaining frame has a vertical axis of rotation if the base element is arranged in a vertical plane, and is configured to be pivoted from a position hearing against the base element into a position protruding from a base frame.

15. The system according to claim 8, wherein the cover element of the goods receipt box is configured to be secured using an electromechanical lock and also comprises a manually actuatable mechanical closure element configured to fasten the cover to the retaining frame.

16. The system according to claim 8, wherein the tub-shaped bottom element has a third fastening component on the goods receipt box, wherein the third fastening component is configured to be placed around a lower region of a base frame via positive engagement and is configured to be releasably connected to the base frame via a pin or split pin connection using at least one pin or split pin configured to be guided through aligned cutouts in the third fastening component and the base frame.

17. The system according to claim 8, wherein a number plate carrier is arranged on a base element of the retaining frame and/or on the bottom element of the goods receipt box.

18. The system according to claim 8, wherein an anchoring element comprising a flexible band is configured to be inserted into a gap region between a door or luggage compartment lid and the vehicle body, and is arranged on the bottom element of the goods receipt box.
